(19) United States
(12) Patent Application Publication
(10) Pub. No.: US 2019/0070637 A1
(43) Pub. Date: Mar. 7, 2019

(54) VIBRATORY SCREEN ASSEMBLY WITH IMPROVED STRUCTURAL BRACING

(71) Applicant: Johnson Crushers International, Inc., Eugene, OR (US)

(72) Inventor: Wills Boothe, Veneta, OR (US)

(73) Assignee: Johnson Crushers International, Inc., Eugene, OR (US)

(21) Appl. No.: 16/112,223

(22) Filed: Aug. 24, 2018

Related U.S. Application Data
(60) Provisional application No. 62/553,561, filed on Sep. 1, 2017.

(51) Int. Cl. B07B 1/46; B07B 1/36

(52) U.S. Cl. CPC B07B 1/4609; B07B 1/36

(57) ABSTRACT

A vibratory screen assembly with improved structural bracing having a vibratory screen deck defined by pairs of side and end walls that are arranged in a rectangular configuration. Cross members are spaced along the length of the screen deck in parallel relationship with each other and extend between the side walls of the screen deck. Bracing components are mounted exclusively between adjacent pairs of cross members and increase the flexural frequency of the vibratory screen deck. Each bracing component includes a main segment configured to extend between adjacent cross members and end sections formed at each end of the main segment. The end sections are angled with respect to the main segment and are configured to mount to the cross members to brace the screen deck.

### CROSS-REFERENCE TO RELATED APPLICATION

This application claims the benefit of U.S. Provisional Patent Application No. 62/553,561, filed on Sep. 1, 2017 and entitled VIBRATORY SCREEN ASSEMBLY WITH IMPROVED STRUCTURAL BRACING, which is incorporated herein by reference in its entirety.

### FIELD OF THE INVENTION

The present invention relates generally to a vibratory screen assembly for classifying materials by particle size. More particularly, the invention relates to structural bracing for a vibratory screen assembly that increases the natural frequency of the screen assembly by stiffening the individual screen decks to enable the screen assembly to operate at higher operating speeds.

### BACKGROUND OF THE INVENTION

Vibratory screen assemblies are used to classify and separate material into two or more differently sized products. A typical vibratory screen assembly is comprised of one or more screen decks which attach to a screen frame that includes a pair of side plates. These screen decks may be mounted in an inclined or horizontal configuration. Each screen deck generally comprises a relatively rigid frame upon which a sizing medium is laid or supported. Sizing media may comprise woven wire cloth or perforated plates, or other types of media known to those having ordinary skill in the art. The sizing media has openings that dictate the largest sized material particle that can pass through the media. An impulse mechanism is provided to generate vibrational motion and to impart such motion to the screen deck(s) of the screen assembly. This vibration is designed to stratify the material as it flows across the media and to expose the material particles to the media openings. Material to be classified by particle size flows across the length of each screen deck and across the sizing media as the impulse mechanism vibrates the screen deck. The vibrations imparted to the screen deck cause material small enough to pass through the openings in the sizing media to pass through to a lower screen deck or transfer chute or conveyor. It also helps to convey the material across the screen deck and prevents material build-up on the sizing media. The screen assembly is typically supported by springs which isolate the assembly from a screen base.

Vibratory screen assemblies are large structures which are designed to vibrate so that bulk material fed to them can be classified and/or conveyed. The ideal mode of vibration for these assemblies is as a rigid body, i.e. the structure moves on the supporting springs as a stiff rigid body without appreciable flexure. However, all vibratory screen assemblies have natural modes of flexural vibration, each with a characteristic frequency. When a screen assembly has a mode of flexural vibration with a characteristic frequency that is close to the operating frequency of the impulse mechanism, resonance will occur as the machine is operated, likely resulting in damage to the assembly. When designing a vibratory screen assembly, measures are generally taken to ensure that the characteristic frequency of the screen structure is not the same as the operating frequency of the impulse mechanism. One design measure that is frequently employed is to add bracing structures to the screen decks, which stiffens the structure and increases the characteristic frequency. The use of the terms “natural frequency” and “characteristic frequency” herein is assumed to relate to any of the characteristic frequencies of flexural vibration of the screen structure unless otherwise stated.

A first embodiment of a conventional screen deck is shown in FIG. 1. As shown therein, screen deck 10 includes a pair of side walls 11 and 12, and a pair of end walls 13 and 14 that are arranged in a rectangular configuration. Multiple stringers 15 are spaced across the width of the screen deck 10 in parallel relationship with each other. Each stringer 15 extends between end wall 13 and end wall 14. Similarly, a plurality of cross members 16 are spaced along the length of the screen deck in parallel relationship with each other, and each cross member 16 extends between side wall 11 and side wall 12. Two bracing members 17, comprising long bracing segments 18 and short bracing segments 19, are attached to the side walls and the cross members. Bracing segments 18 and 19 are not of the same length and are located in specific locations in the screen deck with respect to each other. Thus, bracing segments 18 are bolted to adjacent cross members 16 and bracing segments 19 are bolted to a cross member 16 and a side wall (11 or 12). Bracing segments 18 and 19 are generally comprised of square or round tubing. Consequently, conventional bracing members 17 are generally quite heavy and are expensive to fabricate and install. Because of the weight and expense added by conventional bracing, only as much conventional bracing is used as is necessary to obtain a desired increase in the natural frequency.

U.S. Pat. No. 6,953,121 describes a second embodiment of a conventional screen deck, shown in FIGS. 2 and 3, that comprises an improvement over the first embodiment shown in FIG. 1. As shown in FIG. 2, vibratory screen assembly 20 includes three screen decks 21, 22 and 23 that are disposed between two side plates 24 and 25 and are arranged in a vertically parallel relationship to each other. FIG. 3 shows screen deck 21, the structure of which is essentially identical to that of screen decks 22 and 23. Screen deck 21 includes a pair of side walls 26 and 27, and a pair of end walls 28 and 29 that are arranged in a rectangular configuration. Multiple stringers 30 are spaced across the width of the screen deck 21 in parallel relationship with each other. Each stringer 30 extends between end wall 28 and end wall 29. Similarly, a plurality of cross members 32 are spaced along the length of the screen deck in parallel relationship with each other, and each cross member 32 extends between side wall 26 and side wall 27. The significant difference between prior art screen deck 10 (shown in FIG. 1) and prior art screen deck 21 is the presence of three bracing members 34 in screen deck 21, as opposed to two bracing members 17 in screen deck 10. Bracing members 34, comprise long bracing segments 36 and short bracing segments 38, and are attached to the side walls and the cross members. According to the patent, the addition of the middle bracing member (seen by comparing FIG. 3 and FIG. 1) increased the weight of screen deck 21 (over that of screen deck 10 shown in FIG. 1) by about 18% and the natural frequency by about 37%. As best shown in FIG. 3, bracing segments 36 and 38 are not of the same length and are located in specific locations in the screen deck with respect to each other. Thus, bracing segments 36 are bolted to adjacent cross members 32 and bracing segments 38 are bolted to a cross member 32 and a side wall (26 or 27). Bracing segments 36 and 38 are generally comprised of square or round tubing. Consequently, conventional bracing members 34 are generally quite heavy and are expensive to fabricate and install. Despite the fact that the addition of the third bracing member adds weight and expense to the screen deck (when compared to screen deck 10), there are circumstances when the additional flexural stiffness obtained by adding the third bracing member is an acceptable trade-off. In any event, only as much conventional bracing is used as is necessary to obtain a desired increase in the natural frequency.

It would be desirable if a method for bracing could be devised that would provide an increase in the natural frequency without substantially increasing the weight added. It would also be desirable if bracing structures could be provided that are easy and inexpensive to fabricate and easy to install.

### Advantages of a Preferred Embodiment of the Invention

Among the advantages of a preferred embodiment of the invention is that it provides a bracing configuration that provides a substantial increase in the natural frequency. Another advantage of a preferred embodiment of the invention is that it provides such a bracing configuration while increasing the weight added to the screen deck by an amount that is less than would be added with conventional bracing. Yet another advantage of a preferred embodiment of the invention is that it provides bracing structures that are easy and inexpensive to fabricate and easy to install. Other advantages and features of this invention will become apparent from an examination of the drawings and the ensuing description.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity.

### SUMMARY OF THE INVENTION

The above and other needs are met by a system for bracing a screen deck by employing a plurality of bracing components that are preferably made of flat plate, which are attached only to the cross members of the screen deck. The bracing components are arranged so that, in most locations, at least two bracing components are attached to a cross member using a single fastener or set of fasteners. In a preferred embodiment of the invention, the bracing components are each identical to the others, and they are configured and arranged to form an angle within the range of 35°-55°, preferably about 45°, with the cross members to which they are attached.

In order to facilitate an understanding of the invention, the preferred embodiment of the invention, as well as the best mode known by the inventor for carrying out the invention, is illustrated in the drawings, and a detailed description thereof follows. It is not intended, however, that the invention be limited to the particular embodiment described or to use in connection with the apparatus illustrated herein. Therefore, the scope of the invention contemplated by the inventor includes all equivalents of the subject matter described herein, as well as various modifications and alternative embodiments such as would ordinarily occur to one skilled in the art to which the invention relates. The inventor expects skilled artisans to employ such variations as seem to them appropriate, including the practice of the invention otherwise than as specifically described herein. In addition, any combination of the elements and components of the invention described herein in any possible variation is encompassed by the invention, unless otherwise indicated herein or clearly excluded by context.

### BRIEF DESCRIPTION OF THE DRAWINGS

The presently preferred embodiments of the invention are illustrated in the accompanying drawings, in which like reference numerals represent like parts throughout, and in which:

FIG. 1 is a perspective view illustrating a prior art screen deck having two “X”-shaped bracing components, including long segments mounted between cross members of the screen deck and short segments mounted between cross members and side walls of the screen deck;

FIGS. 2 and 3 are perspective views of a prior art screen deck having three “X”-shaped bracing components similar to those shown in FIG. 1;

FIG. 4 is a top plan view of a screen deck having “Z”-shaped bracing components mounted exclusively between cross members of the screen deck according to an embodiment of the present invention;

FIG. 5 is a sectional view of the screen deck of FIG. 4 taken along line 5-5;

FIG. 5A is a detail view of a circled portion of the screen deck of FIG. 5 identified by the letter “A”;

FIG. 5B is a detail view of a circled portion of the screen deck of FIG. 5 identified by the letter “B”;

FIG. 6 is a perspective view of the screen deck of FIG. 4; and

FIG. 7 is a perspective view illustrating a “Z”-shaped bracing component according to an embodiment of the present invention.

### DESCRIPTION OF THE PREFERRED EMBODIMENTS OF THE INVENTION

This description of the preferred embodiments of the invention is intended to be read in connection with the accompanying drawings, which are to be considered part of the entire written description of this invention. The drawings are not necessarily to scale, and certain features of the invention may be shown exaggerated in scale or in somewhat schematic form in the interest of clarity and conciseness.

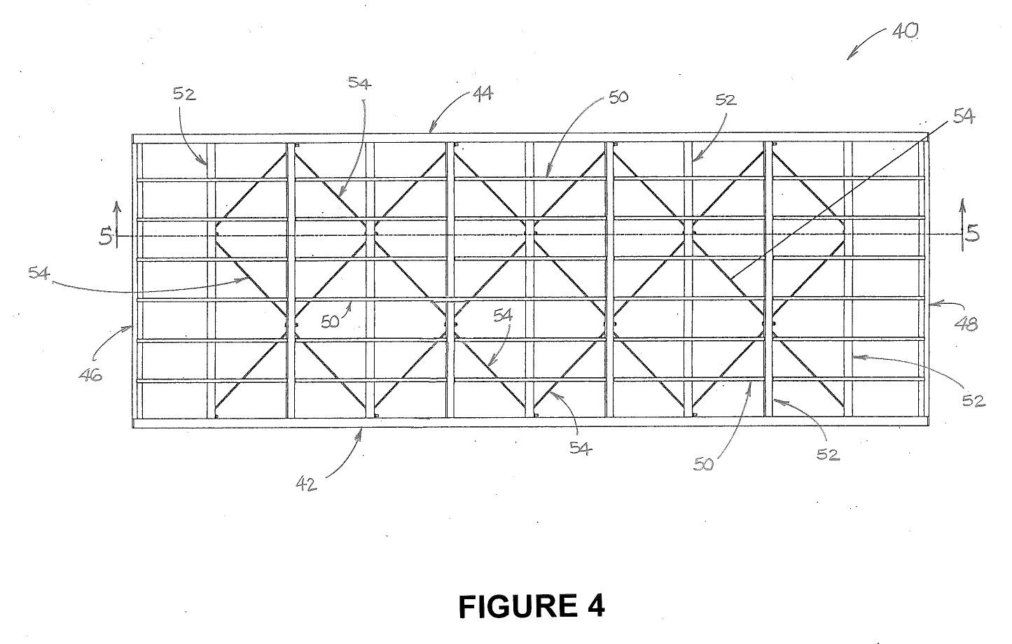

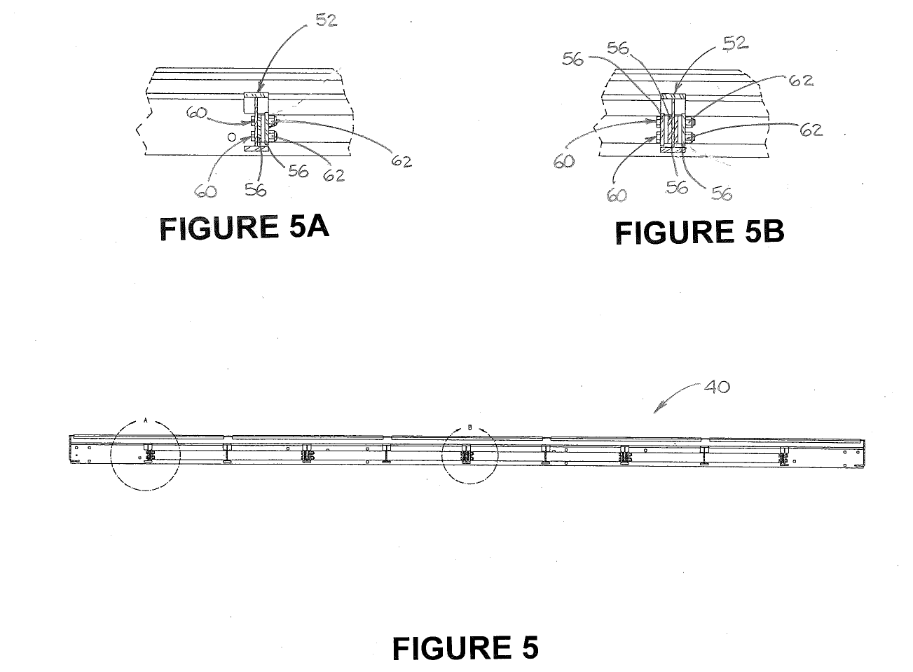

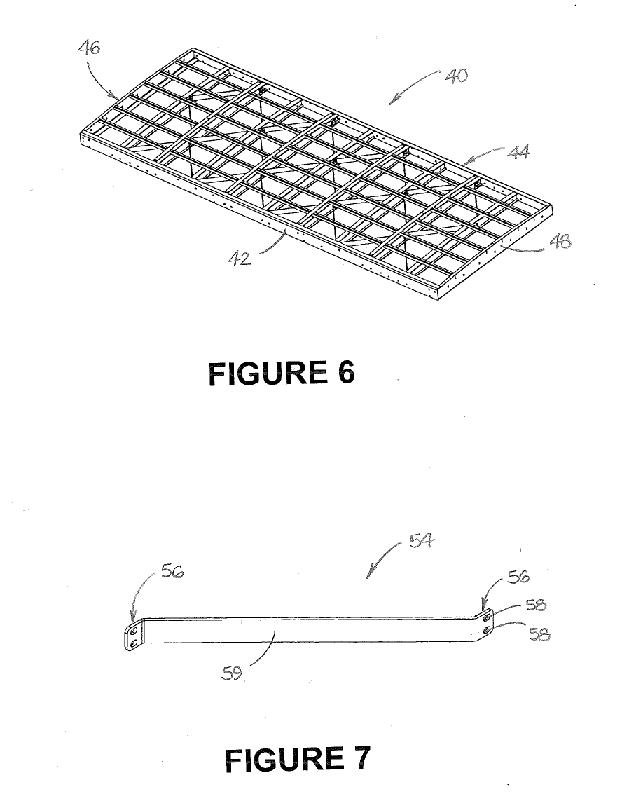

Referring now to FIGS. 4-7, there is illustrated a screen deck 40 according to a preferred embodiment of the invention. As shown therein, screen deck 40 includes a pair of side walls 42 and 44, and a pair of end walls 46 and 48 that are arranged in a rectangular configuration. Multiple stringers 50 are spaced across the width of the screen deck 40 in parallel relationship with each other. Each stringer 50 extends between end wall 46 and end wall 48. Similarly, a plurality of I-beam shaped cross members 52 are spaced along the length of the screen deck in parallel relationship with each other, and each of these cross members extends between side wall 42 and side wall 44. A plurality of bracing components 54 are attached only to the cross members. Preferably, as best shown in FIG. 7, bracing components 54 are somewhat “Z”-shaped and comprise main flat plate segments 59 that have angled end sections 56 which include a pair of fastener slots 58. In the preferred embodiment of the invention, bracing components 54 are adapted to form an angle within the range of 35°-55°, preferably about 45°, with the cross members 52 to which they are attached. In this embodiment of the invention, each of end sections 56 is angled with respect to the main segment 59 of the bracing component to permit easy attachment of two bracing components (shown in FIG. 5A) or four bracing components (shown in FIG. 5B) to a cross member 52 using a plurality of fasteners such as bolts 60 and nuts 62. Preferably, main segment 59 is adapted for form an angle within the range of 125-145°, preferably about 135°, with each end section 56. In only two locations on screen deck 40 is a single bracing component attached to a cross member. These two locations are at the leftmost cross member 52 near side wall 42 (nearest to the joint between side wall 42 and end wall 46), as shown in FIG. 4, and at the rightmost cross member 52 near side wall 42 (nearest to the joint between side wall 42 and end wall 48), also as shown in FIG. 4. Of course, other means of fastening the bracing components to the cross members may be employed, as well as other configurations of the bracing components 54 themselves.

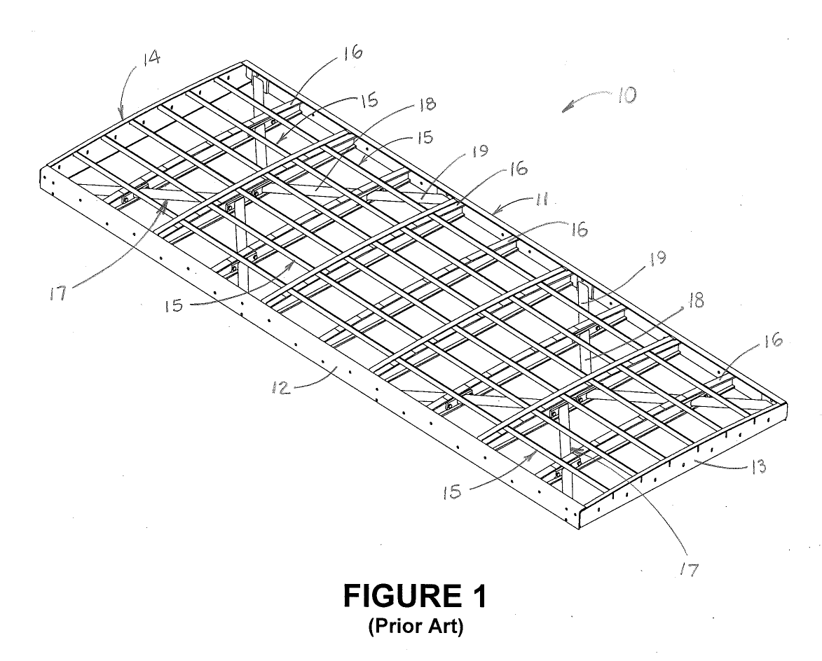

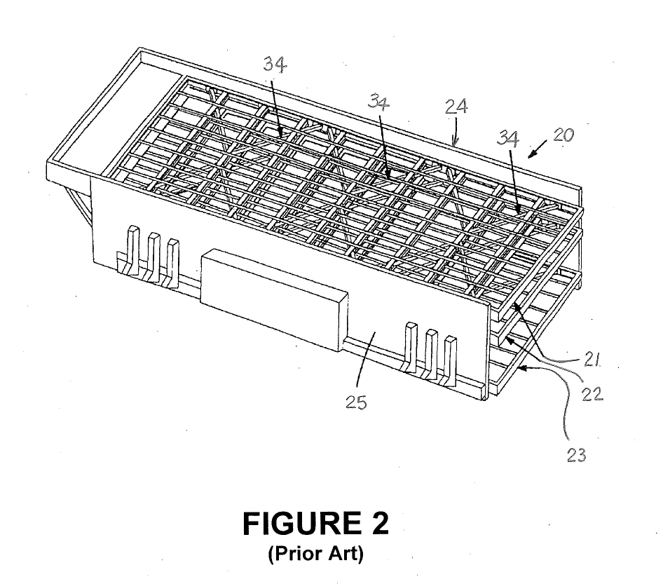

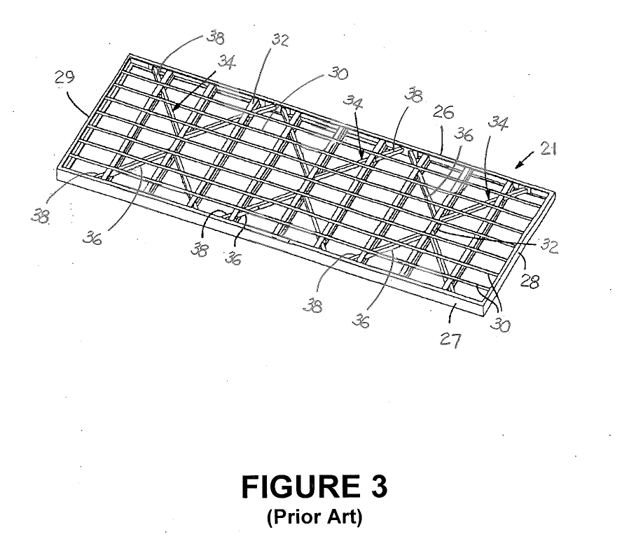

Physical testing was performed to quantify the improvements that may be obtained by employing the preferred embodiment of invention shown in FIGS. 4-7 over a conventional bracing configuration such as is shown in FIG. 1 for a screen deck of the same dimensions. The conventional bracing added 1485 lbm to the screen deck, and resulted in an average characteristic flexural frequency of 982 cycles per minute (s=26 cpm and n=5). By employing the preferred embodiment of the invention on a screen deck of the same size, 785 lbm of bracing was added to the screen deck, resulting in a characteristic flexural frequency of 1125 cycles per minute. In this test, therefore, the invention provided an improvement of about 15% in stiffness over that of conventional bracing while decreasing the mass of the bracing components by about 47%. Furthermore, the time required to install the conventional bracing shown in FIG. 1 was about 16 hours, whereas the time required to install the bracing of the preferred embodiment of the invention was only about 1.75 hours. Finally, the cost of the bracing according to the invention was considerably less than that of the conventional bracing.

The invention thus provides a bracing configuration that provides an increase in the natural frequency of a screen deck without substantially increasing the weight added. Furthermore, the preferred embodiment of the invention provides identically-shaped bracing components that are easy and inexpensive to fabricate and easy to install.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A vibratory screen assembly with improved structural bracing comprising:
a vibratory screen deck defined by a pair of side walls and a pair of end walls that are arranged in a rectangular configuration;
a plurality of cross members spaced along the length of the screen deck in parallel relationship with each other, each cross member extending between the side walls; and
a plurality of bracing components mounted exclusively between adjacent pairs of cross members and configured to increase the flexural frequency of the vibratory screen deck, each bracing component comprising:
a main segment configured to extend between adjacent cross members; and
end sections formed at each end of the main segment and angled with respect to the main segment and configured to mount to the cross members to brace the screen deck.

2. The vibratory screen assembly of claim 1 wherein all bracing components have a uniform size and geometry.

3. The vibratory screen assembly of claim 1 wherein the cross members are I-beam shaped.

4. The vibratory screen assembly of claim 1 wherein each end section of the plurality of bracing components is configured to lie flat against the cross member when the bracing component is mounted to the cross member.

5. The vibratory screen assembly of claim 1 wherein at least two separate bracing components are mounted between each adjacent pair of cross members.

6. The vibratory screen assembly of claim 5 wherein the main segment of one of the at least two bracing components extends between adjacent cross members in a direction that is not parallel with the direction that the other of the at least two bracing components extends between adjacent cross members.

7. The vibratory screen assembly of claim 1 further comprising:
a fastener slot formed in each end section of each bracing component;
a fastener slot formed in the cross members that correspond with the fastener slots in each end section; and
a fastener sized and configured for insertion through each of the corresponding fastener slots in the end sections and cross member for removably connecting the end section to the cross member.

8. The vibratory screen assembly of claim 7 wherein the majority of the bracing components are arranged so that at least two bracing components are attached to a cross member using the same fastener.

9. The vibratory screen assembly of claim 1 wherein the end sections of each of the plurality of bracing components are parallel with one another, the main segment is angled between the two parallel end sections, and the end sections extend outwardly away from ends of the main segment.

10. The vibratory screen assembly of claim 1 wherein each bracing component comprises a single, continuous flat plate with bends located between the main segment and each end section.

11. The vibratory screen assembly of claim 1 wherein the main segment forms an angle of about 125° to about 145° with each end section such that a supplementary angle formed between the main segment and each adjacent cross member is about 35° to about 55°.

12. A method for improving structural bracing of a vibratory screen deck comprising the steps of:
providing a vibratory screen deck comprising a pair of side walls and a pair of end walls that are arranged in a rectangular configuration, a plurality of stringers extending between the end walls and spaced across the width of screen deck in parallel relationship with each other, and a plurality of cross members extending between the side walls and spaced along the length of the screen deck in parallel relationship with each other;
providing a plurality of bracing components, each comprising a main segment and end sections formed at each end of the main segment and angled with respect to the main segment; and
mounting end sections of the plurality of bracing components exclusively to cross members such that the main segment extends at an angle between adjacent cross members.

13. The method of claim 12 wherein at least two bracing components are mounted between each pair of adjacent cross members.

14. The method of claim 13 further comprising the step of arranging the plurality of bracing components such that the main segment of one of the at least two bracing components extends between adjacent cross members in a direction that is not parallel with the direction that the other of the at least two bracing components extends between adjacent cross members.

15. The method of claim 12 further comprising the step of removably connecting the bracing members to the cross members by passing fasteners through corresponding fastener slots formed in both the cross member and the end section of the bracing component.

16. The method of claim 15 which includes arranging the majority of the bracing components so that at least two bracing components are attached to a cross member using the same fastener.

17. The method of claim 12 wherein, when the end sections of the bracing components are mounted to the cross members, the main segment forms an angle of about 125° to about 145° with each end section such that a supplementary angle formed between the main segment and each adjacent cross member is about 35° to about 55°.
